(19) United States
(12) Patent Application Publication
(10) Pub. No.: US 2026/0203803 A1
(43) Pub. Date: Jul. 16, 2026

(54) METHOD AND SYSTEM FOR PROVIDING A RECOMMENDATION FOR SELECTING A VEHICLE

(71) Applicant: JPMorgan Chase Bank, N.A., New York, NY (US)

(72) Inventor: Gangadharan KRISHNAMOORTHY, Hyderabad (IN)

(73) Assignee: JPMorgan Chase Bank, N.A., New York, NY (US)

(21) Appl. No.: 19/071,123

(22) Filed: Mar. 5, 2025

(30) Foreign Application Priority Data
Jan. 10, 2025 (IN) 202511002489

(51) Int. Cl. G06Q 30/0601; G07C 5/04; G07C 5/08

(52) U.S. Cl. CPC G06Q 30/0631; G07C 5/04; G07C 5/0808

(57) ABSTRACT

A method and system for providing a recommendation for selecting a vehicle are disclosed. The method includes receiving diagnostic data associated with a vehicle. Next, the method includes deriving a first set of parameters based on an analysis of the diagnostic data. Next, the method includes processing the diagnostic data and the first set of parameters using a trained model to generate a user profile and a plurality of scores associated with the user profile. Next, the method includes comparing each score within the plurality of scores to corresponding predetermined threshold levels for determining a vehicle recommendation for the user profile. Next, the method includes providing the vehicle recommendation to a user.

### CROSS-REFERENCE TO RELATED APPLICATIONS

This application claims priority benefit from Indian Application No. 202511002489, filed on Jan. 10, 2025 in the India Patent Office, which is hereby incorporated by reference in its entirety.

### FIELD OF THE DISCLOSURE

This technology generally relates to the field of automotive technology, and more particularly relates to methods and systems for providing a recommendation for selecting a vehicle.

### Background Information

The following description of the related art is intended to provide background information pertaining to the field of the disclosure. This section may include certain aspects of the art that may be related to various features of the present disclosure. However, it should be appreciated that this section is used only to enhance the understanding of the reader with respect to the present disclosure, and not as admissions of the prior art.

In recent years, the automotive industry and financial institutions have moved towards computing solutions to take advantage of benefits such as generating recommendations, enhanced data accessibility, and improved collaboration. In the automotive industry, the ability to effectively match customers with vehicles that suit their specific needs is crucial for both customer satisfaction and sales optimization. As vehicle options continue to diversify with numerous models and features available, customers often find the selection process overwhelming.

Current methods of vehicle recommendation typically rely on basic demographic data or generic customer preferences, which may not accurately capture the requirements of individual customers.

Traditional approaches to vehicle recommendations may involve reliance on simple online questionnaires. However, these methods often fall short of providing user-specific solutions, resulting in mismatches between customers and vehicles. The present challenge involves accurately identifying suitable customers and recommending the appropriate vehicle that precisely meets their needs.

However, existing methods or systems fail to identify potential customers for automotive purchases and to provide them with personalized vehicle recommendations that align with their unique preferences and requirements.

Hence, in light of these and other existing limitations, there arises an imperative need to provide an efficient solution to overcome the above-mentioned limitations and to provide a method and a system for recommending vehicles to potential customers while understanding their expectations and driving patterns.

### SUMMARY

The present disclosure, through one or more of its various aspects, embodiments, and/or specific features or sub-components, provides, inter alias, various systems, servers, devices, methods, media, programs, and platforms for providing recommendations for selecting vehicles.

According to an aspect of the present disclosure, a method for providing a recommendation for selecting a vehicle is disclosed. The method is implemented by at least one processor. The method includes receiving, by the at least one processor, diagnostic data associated with a vehicle. Next, the method includes deriving, by the at least one processor, a first set of parameters based on an analysis of the diagnostic data. Next, the method includes processing, by the at least one processor using a trained model, the diagnostic data and the first set of parameters to generate a user profile and a plurality of scores associated with the user profile. Next, the method includes comparing, by the at least one processor, each score within the plurality of scores to corresponding predetermined threshold levels to determine a vehicle recommendation for the user profile. Next, the method includes providing, by the at least one processor, the vehicle recommendation to a user.

In accordance with an exemplary embodiment, the diagnostic data may include at least one from among a throttle position, an engine revolutions per minute (RPM), a fuel consumption rate, an engine load, a steering angle, a brake pedal pressure, a transmission gear position, vehicle stability control data, a driving global positioning system (GPS) location, a driving time, a driving duration, and a coolant temperature.

In accordance with an exemplary embodiment, the first set of parameters may include at least one from among a time of day, a trip duration, frequency of stops, route types, a driving smoothness, an acceleration pattern, a deceleration pattern, and an ideal time.

In accordance with an exemplary embodiment, the diagnostic data may be received from an on-boarding diagnostic (OBD) module.

In accordance with an exemplary embodiment, the method may further include receiving, by the at least one processor, feedback from the user in response to the vehicle recommendation.

In accordance with an exemplary embodiment, the diagnostic data may be received upon successful validation and transformation by the at least one processor.

In accordance with an exemplary embodiment, the trained model may be trained using a set of vehicle data associated with a plurality of vehicles and a set of user profile data associated with a plurality of users.

In accordance with an exemplary embodiment, the method may further include providing, by the at least one processor, the vehicle recommendation to at least one external application that is associated with a platform.

According to another aspect of the present disclosure, a computing device configured to implement an execution of a method for providing a recommendation for selecting a vehicle is disclosed. The computing device includes a processor; a memory; and a communication interface coupled to each of the processor and the memory. The processor may be configured to receive diagnostic data associated with a vehicle. Next, the processor may be configured to derive a first set of parameters based on an analysis of the diagnostic data. Next, the processor may be configured to process, using a trained model, the diagnostic data and the first set of parameters to generate a user profile and a plurality of scores associated with the user profile. Next, the processor may be configured to compare each score within the plurality of scores to corresponding predetermined threshold levels to determine a vehicle recommendation for the user profile. Next, the processor may be configured to provide the vehicle recommendation to a user.

In accordance with an exemplary embodiment, the diagnostic data may include at least one from among a throttle position, an engine RPM, a fuel consumption rate, an engine load, a steering angle, a brake pedal pressure, a transmission gear position, vehicle stability control data, a driving GPS location, a driving time, a driving duration, and a coolant temperature.

In accordance with an exemplary embodiment, the first set of parameters may include at least one from among a time of day, a trip duration, frequency of stops, route types, a driving smoothness, an acceleration pattern, a deceleration pattern, and an ideal time.

In accordance with an exemplary embodiment, the diagnostic data may be received from an OBD module.

In accordance with an exemplary embodiment, the processor may be configured to receive feedback from the user in response to the vehicle recommendation.

In accordance with an exemplary embodiment, the diagnostic data may be received upon successful validation and transformation by the at least one processor.

In accordance with an exemplary embodiment, the trained model may be trained using a set of vehicle data associated with a plurality of vehicles and a set of user profile data associated with a plurality of users.

In accordance with an exemplary embodiment, the processor may be configured to provide the vehicle recommendation to at least one external application that is associated with a platform.

According to yet another aspect of the present disclosure, a non-transitory computer-readable storage medium storing instructions for providing a recommendation for selecting a vehicle is disclosed. The instructions include executable code which, when executed by a processor, may cause the processor to receive diagnostic data associated with a vehicle; derive a first set of parameters based on an analysis of the diagnostic data; process, using a trained model, the diagnostic data and the first set of parameters to generate a user profile and a plurality of scores associated with the user profile; compare each score within the plurality of scores to corresponding predetermined threshold levels to determine a vehicle recommendation for the user profile; and provide the vehicle recommendation to a user.

In accordance with an exemplary embodiment, the diagnostic data may include at least one from among a throttle position, an engine RPM, a fuel consumption rate, an engine load, a steering angle, a brake pedal pressure, a transmission gear position, vehicle stability control data, a driving GPS location, a driving time, a driving duration, and a coolant temperature.

In accordance with an exemplary embodiment, the first set of parameters may include at least one from among a time of day, a trip duration, frequency of stops, route types, a driving smoothness, an acceleration pattern, a deceleration pattern, and an ideal time.

In accordance with an exemplary embodiment, the diagnostic data may be received from an OBD module.

In accordance with an exemplary embodiment, the executable code when executed may further cause the processor to receive feedback from the user in response to the vehicle recommendation.

In accordance with an exemplary embodiment, the diagnostic data may be received upon successful validation and transformation by the at least one processor.

In accordance with an exemplary embodiment, the trained model may be trained using a set of vehicle data associated with a plurality of vehicles and a set of user profile data associated with a plurality of users.

In accordance with an exemplary embodiment, the executable code when executed may further cause the processor to provide the vehicle recommendation to at least one external application that is associated with a platform.

### BRIEF DESCRIPTION OF THE DRAWINGS

The present disclosure is further described in the detailed description which follows, in reference to the noted plurality of drawings, by way of non-limiting examples of exemplary embodiments of the present disclosure, in which like characters represent like elements throughout the several views of the drawings.

FIG. 1 illustrates an exemplary computer system for providing a recommendation for selecting a vehicle, in accordance with an exemplary embodiment of the present disclosure.

FIG. 2 illustrates an exemplary diagram of a network environment for providing a recommendation for selecting a vehicle, in accordance with an exemplary embodiment of the present disclosure.

FIG. 3 illustrates a system diagram for providing a recommendation for selecting a vehicle, in accordance with an exemplary embodiment of the present disclosure.

FIG. 4 illustrates an exemplary method flow diagram for providing a recommendation for selecting a vehicle, in accordance with an exemplary embodiment of the present disclosure.

FIG. 5 illustrates a block diagram representing a system for providing a recommendation for selecting a vehicle, in accordance with an exemplary embodiment of the present disclosure.

### DETAILED DESCRIPTION

Exemplary embodiments will now be described with reference to the accompanying drawings. The invention may, however, be embodied in many different forms and should not be construed as limited to the embodiments set forth herein; rather, these embodiments are provided so that this invention will be thorough and complete, and will fully convey its scope to those skilled in the art. The terminology used in the detailed description of the particular exemplary embodiments illustrated in the accompanying drawings is not intended to be limiting. In the drawings, like numbers refer to like elements.

The specification may refer to “an”, “one”, or “some” embodiment(s) in several locations. This does not necessarily imply that each such reference is to the same embodiment(s), or that the feature only applies to a single embodiment. Single features of different embodiments may also be combined to provide other embodiments.

As used herein, the singular forms “a”, “an”, and “the” are intended to include the plural forms as well, unless expressly stated otherwise. It will be further understood that the terms “include”, “comprises”, “including”, and/or “comprising” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to herein as being “connected” or “coupled” to another element, it can be directly connected or coupled to the other element or intervening elements may be present. Furthermore, “connected” or “coupled” as used herein may include wirelessly connected or coupled. As used herein, the term “and/or” may include any and all combinations and arrangements of one or more of the associated listed items. Also, as used herein, the phrase “at least one” means and may include “one or more” and such phrases or terms can be used interchangeably.

Unless otherwise defined, all terms (including technical and scientific terms) used herein have the same meaning as commonly understood by one of ordinary skilled in the art to which this invention pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The figures depict a simplified structure only showing some elements and functional entities, all being logical units whose implementation may differ from what is shown. The connections shown are logical connections and the actual physical connections may be different.

In addition, all logical units and/or controllers described and depicted in the figures may include the software and/or hardware components required for the unit to function. Furthermore, each unit may comprise within itself one or more components, which are implicitly understood. These components may be operatively coupled to each other and may be configured to communicate with each other to perform the function of the said unit.

In the following description, for the purposes of explanation, numerous specific details have been set forth in order to provide a description of the disclosure. It will be apparent, however, that the invention may be practiced without these specific details and features.

Through one or more of its various aspects, embodiments and/or specific features or sub-components of the present disclosure, are intended to bring out one or more of the advantages as specifically described above and noted below.

The examples may also be embodied as one or more non-transitory computer-readable medium having instructions stored thereon for one or more aspects of the present technology as described and illustrated by way of the examples herein. The instructions in some examples may include executable code that, when executed by one or more processors, causes the processors to carry out steps necessary to implement the methods of the examples of this technology that are described and illustrated herein.

Existing recommendation systems rely on general data and may not consider individual preferences, driving habits, or specific needs, leading to less relevant recommendations. Additionally, existing recommendation algorithms often use outdated or static datasets, failing to account for the latest models, features, and market trends. Hence failed to provide more accurate and personalized recommendations for a vehicle purchase.

To overcome the above-mentioned problems, the present disclosure provides a method and system to provide a recommendation for selecting a vehicle. In the present disclosure, at first the system receives diagnostic data associated with a vehicle. Further, the system derives a first set of parameters based on an analysis of the diagnostic data. Next, the system processes, using a trained model, the diagnostic data and the first set of parameters to generate a user profile and a plurality of scores associated with the user profile. Further, the system compares each score within the plurality of scores to corresponding predetermined threshold levels to determine a vehicle recommendation for the user profile. Further, the system provides the vehicle recommendation to the user. This way the system provides a vehicle recommendation for an automotive purchase.

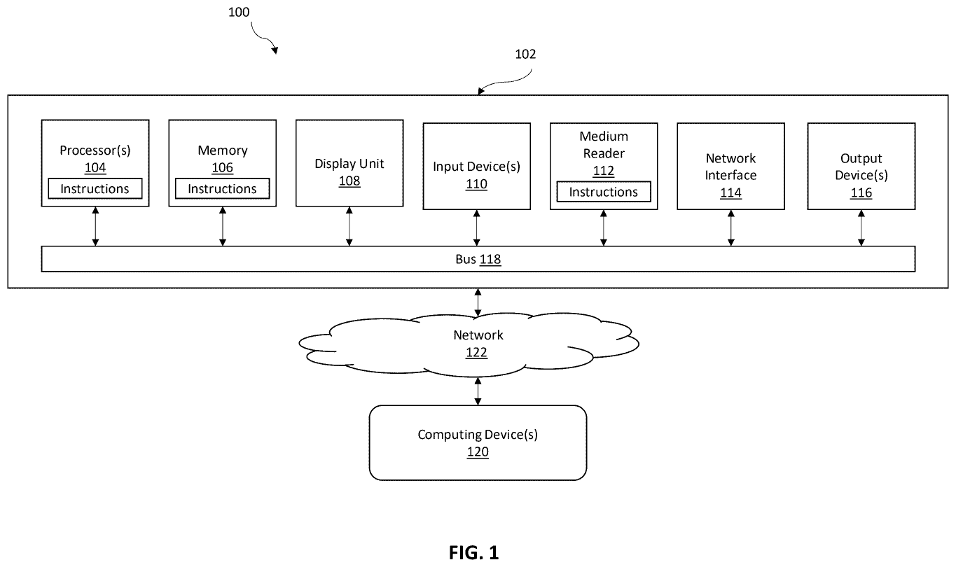

FIG. 1 is an exemplary system for use in accordance with the embodiments described herein. The system 100 is generally shown and may include a computer system 102 which is generally indicated. The term “computer system” may also be referred to herein as “computing device” and such phrases/terms can be used interchangeably in the specifications.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks, or cloud-based environments. Even further, the instructions may be operative in such a cloud-based computing environment.

In a networked deployment, the computer system 102 may operate in the capacity of a server or as a client-user computer in a server-client user network environment, a client-user computer in a cloud-based computing environment, or as a peer computer system in a peer-to-peer (or distributed) network environment. The computer system 102, or portions thereof, may be implemented as, or incorporated into, various devices, such as a personal computer, a virtual desktop computer, a tablet computer, a set-top box, a personal digital assistant, a mobile device, a palmtop computer, a laptop computer, a desktop computer, a communications device, a wireless smartphone, a personal trusted device, a wearable device, a GPS device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 may be tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 may be an article of manufacture and/or a machine component. The processor 104 may be configured to execute software instructions in order to perform functions as described in the various embodiments herein. The processor 104 may be a general-purpose processor or may be part of an application-specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that may include discrete gate and/or transistor logic. The processor 104 may be a central processing unit (CPU), a graphics processing unit (GPU), or both. Additionally, any processor described herein may include multiple processors, parallel processors, or both. Multiple processors may be included in or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories may be an article of manufacture and/or machine components. Memories described herein are computer-readable mediums from which data and executable instructions can be read by a computer. Memories, as described herein, may be random access memory (RAM), read-only memory (ROM), flash memory, electrically programmable read-only memory (EPROM), electrically erasable programmable read-only memory (EEPROM), registers, a hard disk, a cache, a removable disk, tape, compact disk read-only memory (CD-ROM), digital versatile disk (DVD), floppy disk, Blu-ray disk, or any other form of storage medium known in the art. Memories may be volatile or non-volatile, secure and/or encrypted, unsecure and/or unencrypted. As regards the present disclosure, the computer memory 106 may comprise any combination of memories or a single storage.

The computer system 102 may further include a display unit 108, such as a liquid crystal display (LCD), an organic light emitting diode (OLED), a flat panel display, a solid-state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote-control device having a wireless keypad, a microphone coupled to a speech recognition engine, a camera such as a video camera or still camera, a cursor control device, a GPS device, an altimeter, a gyroscope, an accelerometer, a proximity sensor, or any combination thereof. Those skilled in the art will appreciate that various embodiments of the computer system 102 may include multiple input devices 110. Moreover, those skilled in the art will further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor 104, may be used to perform one or more of the methods and processes as described herein. In a particular embodiment, the instructions may reside completely, or at least partially, within the memory 106, the medium reader 112, and/or the processor 104 during execution by the computer system 102.

Furthermore, the computer system 102 may include any additional devices, components, parts, peripherals, hardware, software, or any combination thereof which are commonly known and understood as being included with or within a computer system, such as but not limited to, a network interface 114 and an output device 116. The output device 116 may include but is not limited to, a speaker, an audio out, a video out, a remote-controlled output, a printer, or any combination thereof. Additionally, the term “Network interface” may also be referred to herein as “Communication interface” and such phrases/terms can be used interchangeably in the specifications.

Each of the components of the computer system 102 may be interconnected and communicate via a bus 118 or other communication link. As shown in FIG. 1, the components may each be interconnected and communicate via an internal bus. However, those skilled in the art will appreciate that any of the components may also be connected via an expansion bus. Moreover, the bus 118 may enable communication via any standard or other specification commonly known and understood such as, but not limited to, peripheral component interconnect, peripheral component interconnect expresses, parallel advanced technology attachment, serial advanced technology attachment, etc.

The computer system 102 may be in communication with one or more additional computing devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near-field communication, ultra-band, or any combination thereof. Those skilled in the art will appreciate that additional networks 122 which are known and understood may additionally or alternatively be used and that the exemplary networks 122 are not limiting or exhaustive. Also, while the network 122 is shown in FIG. 1 as a wireless network, those skilled in the art will appreciate that the network 122 may also be a wired network.

The additional computing device 120 is shown in FIG. 1 as a personal computer. However, those skilled in the art will appreciate that, in alternative embodiments of the present application, the computing device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Those skilled in the art will appreciate that the above-listed devices are merely exemplary devices and that the computing device 120 may be any additional device or apparatus commonly known and understood in the art without departing from the scope of the present application. For example, the computing device 120 may be the same or similar to the computer system 102. Furthermore, those skilled in the art will similarly understand that the device may be any combination of devices and apparatuses.

Those skilled in the art will appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations may include distributed processing, component/object distributed processing, and parallel processing. Virtual computer system processing may be constructed to implement one or more of the methods or functionalities as described herein, and a processor 104 described herein may be used to support a virtual processing environment.

As described herein, various embodiments provide methods and systems for providing a recommendation for selecting a vehicle.

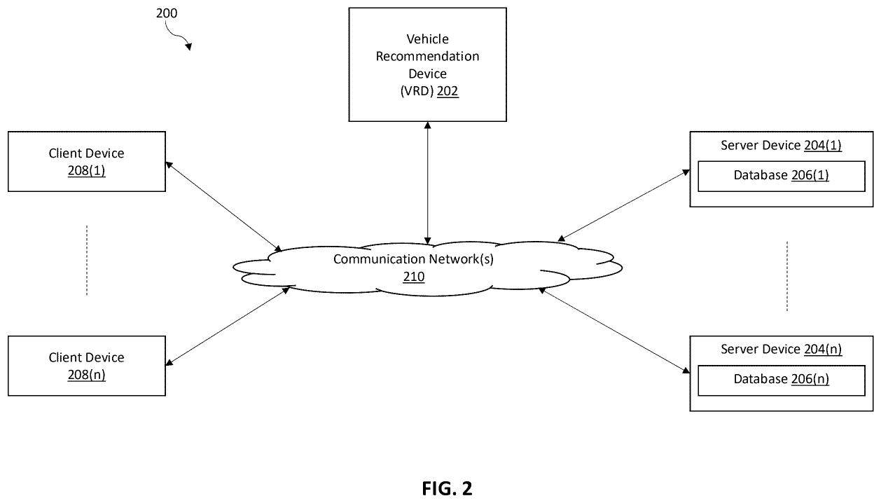

Referring to FIG. 2, a schematic of an exemplary network environment 200 to provide a recommendation for selecting a vehicle is illustrated. In an exemplary implementation, the method is executable on any networked computer platform, such as, for example, a personal computer (PC).

The method to provide a recommendation for selecting a vehicle may be executed by a vehicle recommendation device (VRD) 202. The VRD 202 may be the same or similar to the computer system 102 as described with respect to FIG. 1. The VRD 202 may store one or more applications that may include executable instructions that, when executed by the VRD 202, may cause the VRD 202 to perform desired actions, such as to transmit, receive, or otherwise process network messages, for example, and to perform other actions described and illustrated below with reference to the figures. The application(s) may be implemented as modules or components of other applications. Further, the application(s) may be implemented as operating system extensions, modules, plugins, or the like.

In a non-limiting example, the application(s) may be operative in a cloud-based computing environment. The application(s) may be executed within or as a virtual machine(s) or virtual server(s) that may be managed in a cloud-based computing environment. Also, the application(s), and even the VRD 202 itself, may be located in the virtual server(s) running in a cloud-based computing environment rather than being tied to one or more specific physical network computing devices. Also, the application(s) may be running in one or more virtual machines (VMs) executing on the VRD 202. Additionally, in one or more embodiments of this technology, virtual machine(s) running on the VRD 202 may be managed or supervised by a hypervisor.

In the network environment 200 of FIG. 2, the VRD 202 is coupled to a plurality of server devices 204(1)-204(n) that host a plurality of databases 206(1)-206(n), and also to a plurality of client devices 208(1)-208(n) via communication network(s) 210. A communication interface of the VRD 202, such as the network interface 114 of the computer system 102 of FIG. 1, may operatively couple and communicate between the VRD 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the VRD 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides several advantages including methods, non-transitory computer-readable media, and VRDs that efficiently implement the method to provide recommendations for selecting vehicles.

By way of example only, the communication network(s) 210 may include local area network(s) (LAN(s)) or wide area network(s) (WAN(s)) and can use transmission control protocol/internet protocol (TCP/IP) over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), public switched telephone networks (PSTNs), ethernet-based packet data networks (PDNs), combinations thereof, and the like.

The VRD 202 may be a standalone device or integrated with one or more other devices or apparatuses, such as one or more of the server devices 204(1)-204(n), for example. In one particular example, the VRD 202 may include or be hosted by one of the server devices 204(1)-204(n), and other arrangements are also possible. Moreover, one or more of the devices of the VRD 202 may be in the same or a different communication network including one or more public, private, or cloud-based networks, for example.

The plurality of server devices 204(1)-204(n) may be the same or similar to the computer system 102 or the computing device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. In an example, the server devices 204(1)-204(n) may process requests received from the VRD 202 via the communication network(s) 210 according to the hypertext transfer protocol (HTTP)-based and/or javascript object notation (JSON) protocol, for example, although other protocols may also be used.

The server devices 204(1)-204(n) may be hardware or software or may represent a system with multiple servers in a pool, which may include internal or external networks. The server devices 204(1)-204(n) host the databases or repositories 206(1)-206(n) that are configured to store diagnostic data, data received from third party services, vehicle recommendations, and feedback received from users, for implementation of the features of the present disclosure.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a controller/agent approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to-peer architecture, virtual machines, or within a cloud-based architecture, for example. Thus, the technology disclosed herein is not to be construed as being limited to a single environment and other configurations and architectures are also envisaged.

The plurality of client devices 208(1)-208(n) may also be the same or similar to the computer system 102 or the computing device 120 as described with respect to FIG. 1, including any features or combination of features described with respect thereto. For example, the client devices 208(1)-208(n) in this example may include any type of computing device that can interact with the VRD 202 via communication network(s) 210. Accordingly, the client devices 208(1)-208(n) may be mobile computing devices, desktop computing devices, laptop computing devices, tablet computing devices, or the like, that host chat, e-mail, or voice-to-text applications, for example. In an exemplary implementation, one client device 208 may be a wireless mobile communication device, e.g., a smartphone.

The client devices 208(1)-208(n) may run interface applications, such as standard web browsers or standalone client applications, which may provide an interface to communicate with the VRD 202 via the communication network(s) 210 in order to communicate user requests and information. The client devices 208(1)-208(n) may further include, among other features, a display device, such as a display unit or touchscreen, and/or an input device, such as a keyboard, for example.

Although the exemplary network environment 200 with the VRD 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the VRD 202, the server devices 204(1)-204(n), or the client devices 208(1)-208(n), for example, may be configured to operate as virtual instances on the same physical machine. In other words, one or more of the VRD 202, the server devices 204(1)-204(n), or the client devices 208(1)-208(n) may operate on the same physical device rather than as separate devices communicating through communication network(s) 210. Additionally, there may be more or fewer VRDs 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication, may also be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, packet data networks (PDNs), the Internet, intranets, and combinations thereof.

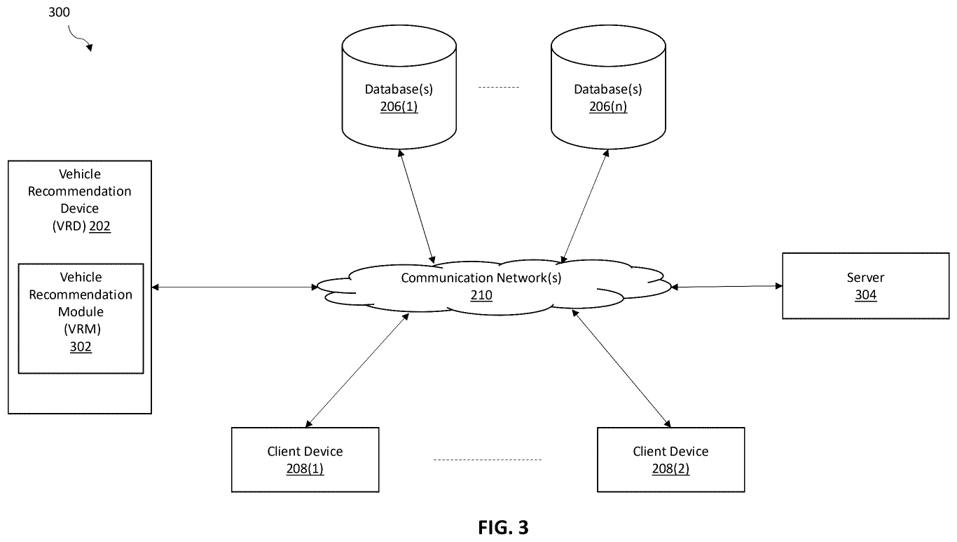

FIG. 3 illustrates a system diagram to provide a recommendation for selecting a vehicle, in accordance with an exemplary embodiment.

As illustrated in FIG. 3, the system 300 may include a VRD 202 within which a vehicle recommendation module (VRM) 302 is embedded, a server 304, a database(s) 206(1) . . . 206(n), a plurality of client devices 208(1) . . . 208(2), and a communication network(s) 210.

According to exemplary embodiments, the system 300 may comprise the VRD 202 including the VRM 302 may be connected to the server 304 and the database(s) 206(1) . . . 206(n) via the communication network(s) 210, but the disclosure is not limited thereto. The VRD 202 may also be connected to the plurality of client devices 208(1) . . . 208(2) via the communication network(s) 210, but the disclosure is not limited thereto. The database(s) 206(1) . . . 206(n) may include a rule database.

In an embodiment, the VRD 202 is described and shown in FIG. 3 which includes the VRM 302, although it may include other rules, policies, modules, databases, or applications, for example. As will be described below, the VRM 302 may be configured to carry out a method to provide a recommendation for selecting a vehicle.

An exemplary system 300 for enabling a mechanism to provide a recommendation for selecting a vehicle by utilizing the network environment of FIG. 2 is shown as being executed in FIG. 3. Specifically, a first client device 208(1) and a second client device 208(2) are illustrated as being in communication with VRD 202. In this regard, the first client device 208(1) and the second client device 208(2) may be “clients” of the VRD 202 and are described herein as such. Nevertheless, it is to be known and understood that the first client device 208(1) and/or the second client device 208(2) need not necessarily be “clients” of the VRD 202, or any entity described in association therewith herein. Any additional or alternative relationship may exist between either or both of the first client device 208(1) and the second client device 208(2) and the VRD 202, or no relationship may exist.

Further, the VRD 202 is illustrated as being able to access one or more database(s) 206(1) . . . 206(n). The VRM 302 may be configured to access these repositories/databases to provide a method to provide recommendations for selecting vehicles. In some embodiments, the server 304 may be the same or equivalent to the server device 204 as illustrated in FIG. 2.

The first client device 208(1) may be, for example, a smartphone. The first client device 208(1) may be any additional device described herein. The second client device 208(2) may be, for example, a personal computer (PC). The second client device 208(2) may also be any additional device described herein.

The process may be executed via the communication network(s) 210, which may comprise plural networks as described above. For example, in an exemplary embodiment, either or both the first client device 208(1) and the second client device 208(2) may communicate with the VRD 202 via broadband or cellular communication. These embodiments are merely exemplary and are not limiting or exhaustive.

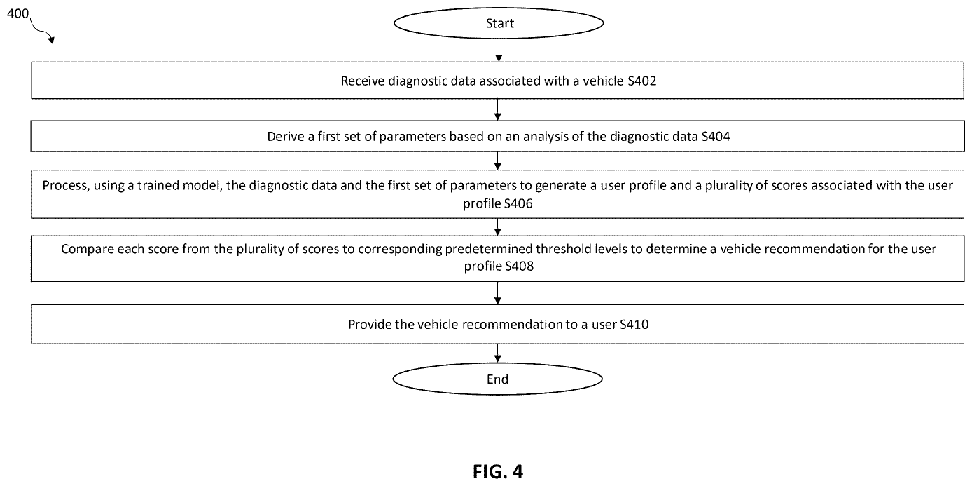

Referring to FIG. 4, an exemplary method 400 is shown for providing a recommendation for selecting a vehicle, in accordance with an exemplary implementation.

The method begins when a user is looking for a recommendation for selecting a vehicle that precisely meets their needs. The method 400 is implemented by at least one processor 104. A user is an individual who interacts with an application or service to receive recommendations for selecting one or more vehicles for an automotive purchase.

At step S402, the method includes receiving, by the at least one processor 104, diagnostic data associated with a vehicle. The diagnostic data may include at least one from among a throttle position, an engine RPM, a fuel consumption rate, an engine load, a steering angle, a brake pedal pressure, a transmission gear position, vehicle stability control data, a driving GPS location, a driving time, a driving duration, and a coolant temperature. The diagnostic data is received upon successful validation and transformation by the at least one processor 104.

The throttle position indicates how far the throttle is open, indicating the driver's acceleration behavior. The throttle position is useful for detecting whether the acceleration is an aggressive acceleration or a normal acceleration. Engine RPM provides insights into how hard an engine is being pushed. For example, high RPMs indicate aggressive driving by a driver (e.g., a user). The fuel consumption rate measures a rate of fuel consumption. Fuel consumption rate helps in classifying drivers based on fuel efficiency and driving style. The engine load indicates how much power the engine is producing relative to its maximum capacity. For example, a higher engine load suggests more aggressive driving of a driver. The steering angle measures the position of a steering wheel. Brake pedal pressure measures the force applied to the brake pedal. Brake pedal pressure is used to detect hard braking events more accurately. The transmission gear position indicates the current gear of the vehicle. Transmission gear position helps to understand driving behavior in different gears. The vehicle stability control data may include, but is not limited to, the data on traction control and stability. Vehicle stability control data is used to detect how often systems of vehicles are engaged, indicating aggressive or unsafe driving. Ambient temperature may detect the air temperature of the surrounding environment. It is to be noted that external temperature can affect driving behavior (e.g., driver may be more cautious driving in cold weather). The coolant temperature data is related to the temperature of the coolant used in the engine of a vehicle. For example, high engine temperatures may suggest prolonged high-speed driving or insufficient cooling. The data related to driving time refers to the actual time spent driving from one location to another. Driving duration data often encompasses the total time required for a trip.

The diagnostic data is received upon successful validation and transformation by the at least one processor 104. In an implementation, the diagnostic data is received from at least one source. The source may include, but is not limited to, an onboard module (e.g., OBD module) or at least one external service (e.g., a third-party service). The OBD module is connected with an OBD part of the vehicle. The diagnostic data may be stored in a database after validation and transformation into a required format. In an exemplary implementation, the diagnostic data is fetched by the onboard module connected with the OBD port of the vehicle for a predetermined time period.

At step S404, the method includes deriving, by the at least one processor 104, a first set of parameters based on an analysis of the diagnostic data. The first set of parameters may include a time of day, a trip duration, a frequency of stops, route types, driving smoothness, an acceleration or deceleration pattern, and/or an ideal time. It is to be noted that the first set of parameters are related to the user driving pattern based on their usage of the vehicle. The first set of parameters may further include cornering behavior analysis.

The time of day classifies driving based on whether driving takes place during rush hour, daytime, or nighttime. For example, the nighttime driving might indicate a preference for less congested roads. The trip duration may refer to an average length of trips providing insights into whether the driver prefers short commutes or long drives. The frequency of stops refers to a number of stops during a trip that can indicate city driving (e.g., frequent stops in a city) versus highway driving (e.g., fewer stops on a highway). The route types refer to the classification of routes where such classification is based on the types of roads frequently used (e.g., urban, suburban, and highway). The route types may help in understanding the preferred driving environments. The driving smoothness measures the consistency of acceleration and braking. For example, smooth driving may indicate conservative driving, while jerky driving indicates aggressiveness. The acceleration or deceleration patterns may include a detailed analysis of acceleration and deceleration curves. For example, sharp and frequent changes may indicate aggressive driving. The cornering behavior analysis may include analysis of steering input and vehicle stability during turns. The cornering behavior analysis refers to a process of studying how a driver handles turns or curves on the road while driving. It involves monitoring the vehicle's steering inputs, the vehicle's response during turns, and overall stability as the vehicle navigates through corners. This type of analysis is useful for understanding the driver's driving style, vehicle dynamics, and safety during turns. For example, aggressive behavior may indicate a sporty driving style. The ideal time refers to the amount of time the vehicle spends idling. For example, high idle time may indicate heavy traffic conditions or frequent short trips.

At step S406, the method includes processing, by the at least one processor 104 using a trained model, the diagnostic data and the first set of parameters to generate a user profile and a plurality of scores associated with the user profile.

In an implementation, the model is trained and optimized using a set of vehicle data associated with a plurality of vehicles and a set of user profile data associated with a plurality of users. In an implementation, the trained model is referred to herein as an artificial intelligence (AI) model developed and optimized using machine learning algorithms.

The user profile enables the disclosed system to track and monitor the driver's performance and behavior over time. By profiling the user specific driving characteristics, the disclosed system can offer customized suggestions that are more likely to resonate with the driver, helping them improve their driving behavior and vehicle performance. The user profile may include user preferences. In an exemplary implementation, the user preferences refer to the specific likes and choices of drivers related to their driving experiences, vehicle features, and services. In yet another exemplary implementation, the user profile may contain a user profile score. The plurality of scores may include a comfort score, an eco-friendly score, a responsiveness score, a traffic adaptability score, a maintenance awareness score, and an urban versus highway driving score.

The comfort score evaluates how smoothly a vehicle is driven and focuses on passenger comfort. In an example, the plurality of parameters analyzed for the generation of comfort score includes but is not limited to acceleration and deceleration smoothness, frequency of hard braking, and steering smoothness. The eco-friendly score evaluates the environmental impact of driving behavior. In an example, the plurality of parameters analyzed for the generation of eco-friendly score includes but is not limited to, the fuel consumption rate, the average speed, and the idle time. The responsiveness score evaluates how quickly and effectively the driver responds to traffic conditions. In an example, the plurality of parameters analyzed for generation of responsiveness score includes but is not limited to throttle response time, brake response time, and steering response time.

The traffic adaptability score evaluates how well the driver adapts to different traffic conditions. In an example, the plurality of parameters analyzed for the generation of responsiveness score includes but is not limited to, variation in speed, frequency of stops and starts, and time of day driving patterns. The maintenance awareness score evaluates how the driver's behavior impacts vehicle's maintenance and longevity. In an example, the plurality of parameters analyzed for the generation of maintenance score includes but is not limited to, frequency of engine over-revving, coolant temperature consistency, and brake and tire wear indicators. Urban versus highway driving score categorizes the driver's preference for urban or highway driving. In an example, the plurality of parameters analyzed for the generation of urban versus highway driving scores may include but is not limited to, average speed, frequency of stops, and/or trip duration.

In an exemplary implementation, a composite user profile score is calculated based on the plurality of scores. An example of calculating the composite user profile score is provided below:

The examples provided in this description are intended for illustrative purposes only and are not to be construed as limiting the scope of the invention. These examples are meant to demonstrate the application of the concepts and methods described herein, and variations and modifications may be made without departing from the essence of the invention.

An example of the composite user profile score for recommending a car is provided as follows: data[user_profile_score']=(data[aggressiveness_score']*0.2+data[efficiency_score']*0.2+data[safety_score']*0.2+data[comfort_score']*0.1+data[eco_friendly_score']*0.1+data[responsiveness_score']*0.1+data[traffic_adaptability_score']* 0.1)

At step S408, the method includes comparing, by the at least one processor 104, each score within the plurality of scores to corresponding predetermined threshold levels to determine a vehicle recommendation for the user profile.

An example of a comparison of the plurality of scores with corresponding predetermined thresholds is provided as follows:
if data[user_profile_score']. mean() >aggressive_threshold:
   recommended_car=“Sports Car”
elif data[eco_friendly_score']. mean()>eco_threshold:
   recommended_car=“Hybrid/Electric Vehicle”
elif data[comfort_score'].mean()>comfort_threshold:
   recommended_car=“Luxury Sedan”
elif data[urban_driving_score'].mean()>urban_threshold:
   recommended_car=“Compact Car”
   else:
      recommended_car=“sedan”

At step S410, the method includes providing, by the at least one processor 104, the vehicle recommendation to the user. The vehicle recommendation may include a recommendation of a vehicle segment (e.g., sedan, a compact vehicle, a sports vehicle) along with a suggestion of at least one vehicle (e.g., Honda City in sedan), a reason to suggest the at least one vehicle (e.g., suggest the recommendation of the compact vehicle if the user is an urban rider), and details of the at least one vehicle. The details of the at least one vehicle may include specification(s) of the vehicle, model(s) of the vehicle, and price of the vehicle.

In an exemplary and non-limiting implementation, the vehicle recommendation is further explained in conjunction with the aforementioned example: If a user profile score is greater than an aggressive threshold then the vehicle recommendation suggests a sports car. If an eco-friendly score is greater than an economic threshold then the vehicle recommendation suggests a hybrid vehicle or an electric vehicle. If the comfort score is greater than the comfort threshold then the vehicle recommendation suggests a luxury sedan. If the urban driving score is greater than the urban threshold then the vehicle recommendation suggests a sedan.

The method further includes receiving, by the at least one processor 104, feedback from the user in response to the vehicle recommendation. The feedback may be received from a user over a platform or a user interface (UI). The feedback may include user input to the trained model for vehicle recommendation. The feedback may be stored in the database for continuous learning, optimization, and training of the trained model. This way the method disclosed in the present disclosure generates more accurate personalized recommendations for an automotive purchase.

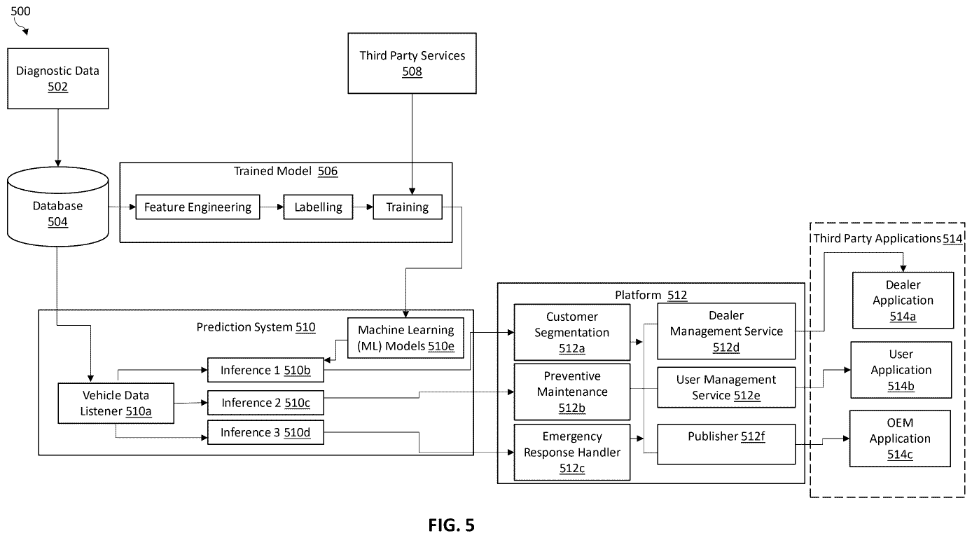

FIG. 5 illustrates a block diagram that represents a system 500 to provide recommendations for vehicles, in accordance with an exemplary embodiment. As illustrated in FIG. 5, the process flow 500 begins with receiving, by a database 504 (hereinafter also referred to as a data capture module), diagnostic data 502 associated with a vehicle. The diagnostic data 502 is received from at least one source. The at least one source may include an OBD module or at least one external service. The OBD module may be connected with an OBD port of the vehicle. The diagnostic data 502 is received upon successful validation and transformation by at least one processor 104. The diagnostic data 502 may include at least one from among a throttle position, engine RPM, a fuel consumption rate, an engine load, a steering angle, a brake pedal pressure, a transmission gear position, vehicle stability control data, a GPS location, a driving time, a driving duration, and a coolant temperature.

Next, the at least one processor 104 of the system 500 derives a first set of parameters based on an analysis of the diagnostic data 502. The first set of parameters may include at least one from among a time of day, a trip duration, frequency of stops, route types, driving smoothness, an acceleration or deceleration pattern, and an ideal time.

In an exemplary implementation, the data capture module 504 provides the diagnostic data 502 to a data ingestion layer. The data capture module 504 includes the data ingestion layer, a data validator, and a data transformer. The data ingestion layer further transmits the received diagnostic data 502 to the data validator. The data validator is a component or tool used to ensure the accuracy, quality, and integrity of data before it is processed or stored. The data validator may perform the following functions such as but not limited to, syntax checking, range checking, type checking, consistency checking, and completeness checking. The data validator may run the collected data against the defined rules to check for errors or inconsistencies and provide the validated data. The defined rules refer to the set of criteria, guidelines, or conditions that are pre-established to assess the accuracy, quality, and integrity of the collected data. The defined rules may include, but not limited to, syntax rules, range rules (e.g., engine temperature, RPM, fuel pressure, and throttle position), type rules, consistency rules (e.g., vehicle speed vs. RPM, fuel consumption vs. efficiency, oxygen sensor vs. air/fuel ratio), completeness rules, and business rules. For example, syntax check: OBD diagnostic trouble codes should follow the format of a letter followed by four digits, e.g., “P0300”. The data validator will check if the codes conform to this pattern. Further, the data transformer receives the validated data from the data validator. A data transformer is a tool or component that modifies, processes or converts data from one format or structure to another, making it suitable for analysis, storage, or integration into the system. The data transformer may perform functions such as, but not limited to, data format conversion, data cleansing, data aggregation, and data filtering. Further, the data transformer sends transformed data along with raw data to a trained model 506 so that the trained model 506 is able to utilize such transformed data for continuous training and learning of the trained model. The trained model 506 may receive information (e.g., vehicle model and specification information) of one or more vehicles from third-party services 508 such as car dealers, car manufacturers, and the like.

The trained model 506 has three stages, such as feature engineering, labeling, and training. Feature engineering may include feature extraction. A process of gathering data (e.g., diagnostic data 502) for model training involves collecting and extracting data from the OBD module. For example, the data in the OBD port is in a serialized format, which needs to be deserialized, validated, and extracted. This process is known as feature extraction. Once the data (e.g., the diagnostic data 502) is collected, it needs to be labeled to train the model 506 using at least one machine learning algorithm (e.g., a supervised learning algorithm). In an exemplary implementation, the model 506 is trained using the extracted features and labelled data.

Further, the trained model 506 is configured to generate a user profile based on analysis of the plurality of parameters and the diagnostic data 502. The trained model 506 is configured to compute various scores (e.g., aggressiveness score, safety score, comfort score, eco-friendly score, responsiveness score, and traffic adaptability score). Similarly, the model 506 can be trained for preventive maintenance and emergency response handling. The trained model 506 transmits the diagnostic data 502 and the plurality of parameters to machine learning model(s) included in a prediction system 510. The prediction system 510 may include machine learning models 510e and a vehicle data listener 510a. The prediction system 510 utilizes data received from the OBD module and all the scores computed by the trained model 506, then following the calculation of each score, a final prediction is made based on the trained model 506. This process is referred to herein as prediction or inference. The vehicle data listener 510a receives the diagnostic data 502 and the first set of parameters from the database 504. The vehicle data listener 510a may generate at least three or more inferences (e.g., an Inference 1 510b, an Inference 2 510c, and an Inference 3 510d) and provide them to a platform 512. The platform may be a cloud based platform.

The Inference 1 510b, generated by the machine learning model 510e, represents a processed output based on the historical diagnostic data and the computed scores. The Inference 1 510b is then transmitted to the vehicle data listener 510a, which actively monitors and captures ongoing vehicle performance metrics. By correlating the insights from the machine learning model 510e with live data from the vehicle, the vehicle data listener 510a is positioned to enhance the accuracy and relevance of the recommendations provided. In the described system, the connection of the Inference 1 510b establishes a critical link between the machine learning model 510e and the vehicle data listener 510a. This connection allows for seamless integration of advanced predictive analytics and real-time data monitoring.

In an exemplary implementation, the at least one processor 104 may be configured to provide the vehicle recommendation to at least one external application (e.g., an application or an application programming interface (API)) that is associated with the platform 512. In an exemplary embodiment, the platform 512 allows an entity (e.g., developers, dealers, third party services, an original equipment manufacturer (OEM) etc.) to create third-party applications 514 (hereinafter also referred to as applications) on top of the platform 512. Developers from various sectors, such as insurance, OEMs, and dealerships, can create applications/third party applications 514 (e.g., a dealer application 514a, a user application 514b, an OEM application 514c) based on the vehicle recommendation (hereinafter also referred to as vehicle recommendation data). This open ecosystem allows the automotive domain to scale significantly. For example, insurance companies can use the vehicle recommendation data to propose appropriate insurance options to their customers, such as recommending an optional comprehensive package for aggressive drivers.

For example, the platform 512 allows developers to run their application on the platform 512 to protect data privacy and utilize the vehicle recommendation for maintaining inventory of vehicles according to demand. In another example, OEMs utilize the vehicle recommendation received via an application for maintaining inventory of products related to vehicles. In an example, aftermarket OEMs suggest their products based on the vehicle recommendation, such as offering hands-free products to tech-savvy drivers.

In yet another example, a user may use an application or API to provide a feedback to train the system for improving the vehicle recommendation.

The platform 512 may include customer segmentation information (hereinafter also referred to as customer segmentation) 512a, preventive maintenance 512b, an emergency response handler 512c, a user management service 512e, a dealer management service 512d, and a publisher 512f. The publisher 512f typically refers to a component or service within the platform 512 that acts as a mediator or facilitator for sharing and distributing information, data, or recommendations generated by the vehicle recommendation system with various stakeholders such as the OEM application 514c. For example, in the user management service 512e users are categorized based on their vehicle recommendation (e.g., based on a predicted car). For instance, all luxury car customers (hereinafter interchangeably referred to as users) are grouped into one segment. The dealer management service 512d offers dealers the chance to share their inventory and register their interest with users. When a user is interested in a specific car, dealers can propose selling their inventory to the interested user. For example, dealer applications 514a can recommend suitable cars from their inventory, highlighting significant discounts to the users. Dealers are given the opportunity to integrate their voice assistants, such as Google Assistant® or Amazon Alexa®, with the dealer management service 512d. The user management service 512e uses the prediction for a given customer and enables the customer to utilize this prediction. The user management service 512e interfaces with the dealer management service 512d to provide the customer with the necessary dealer inventory. It also facilitates feedback collection from the customer. This user management service 512e also interacts with the preventive maintenance 512b. The preventive maintenance 512b plays a crucial role in ensuring that vehicles remain in optimal working condition, minimizing potential issues before they arise, and enhancing the overall user experience. The preventive maintenance 512b can leverage the vehicle recommendation data generated by the platform. For instance, if the vehicle recommendation data indicates that a driver is aggressive or frequently drives in challenging conditions, the preventive maintenance system 512b can suggest more frequent checks or specific maintenance tasks tailored to the driving style and vehicle use.

A User application 514b (e.g., an Android®/IOS® app or voice assistants like Amazon Alexa® or Google Assistant®) interfaces with the customer segmentation 512a and the user management service 512e. The customer segmentation 512a categorizes users based on vehicle recommendations and related behavioral insights, allowing tailored interactions and personalized services. The customer segmentation 512a facilitates various stakeholders, such as dealers and OEMs, by providing data-driven insights to optimize their strategies. Dealers may propose suitable inventory options or discounts to specific users, while OEMs can refine product offerings and inventory planning. The customer segmentation 512a enhances user experience by aligning recommendations and services with individual preferences and needs, fostering engagement and satisfaction.

Customers may install the application on their devices to utilize this recommendation service. OEMs also gain insights into customer usage, car issues, dealer inventory, and dealer-customer interactions through the OEM application 514c. The emergency response handler 512c receives one of the inference (e.g., Inference 2 510c). The integration of Inference 2 510c (e.g., inference relates to specific actionable insights or data points regarding vehicle condition and user behavior) enhances the capabilities of the emergency response handler 512c. The connection between the emergency response handler 512c and the dealer management service 512d plays a vital role in creating a seamless experience for users facing vehicle-related emergencies. By facilitating real-time data sharing, coordinated assistance, and proactive follow-up services, both components enhance user trust, safety, and satisfaction. This integration not only optimizes incident management but also strengthens the relationship between users and dealers, contributing to long-term customer loyalty and improved vehicle management practices. Thereby providing vehicle recommendations on the user application 514b.

It would be appreciated by the person skilled in the art that the system offers a full-circle, adaptable, and intelligent solution for implementing a method for providing a recommendation for selecting a vehicle.

The present disclosure provides numerous advantages as given below. The present method provides a new approach that aims at accurately identifying the most suitable vehicle for a user based on the user's driving pattern and vehicle diagnostic data. The present disclosure helps an individual to review his driving pattern and assists in selecting a vehicle during an automotive purchase. The disclosed method offers comprehensive insights into various models, including features, and helps users make informed choices. The present disclosure saves time for users by quickly narrowing down choices based on specific criteria, reducing the overwhelming number of options.

Although the invention has been described with reference to several exemplary embodiments, it is understood that the words that have been used are words of description and illustration, rather than words of limitation. Changes may be made within the purview of the appended claims, as presently stated, and as amended, without departing from the scope and spirit of the present disclosure in its aspects. Although the invention has been described with reference to particular means, materials, and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” may include a single medium or multiple media, such as a centralized or distributed database, and/or associated caches and servers that store one or more sets of instructions. The terms “computer-readable medium” and “computer-readable storage medium” shall also include any medium that is capable of storing, encoding, or carrying a set of instructions for execution by a processor 104 or that causes a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium may be a random-access memory or other volatile re-writable memory. Additionally, the computer-readable medium may include a magneto-optical or optical medium, such as a disk or tape, or other storage device to capture carrier wave signals such as a signal communicated via a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application-specific integrated circuits, programmable logic arrays, and other hardware devices, may be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

According to an aspect of the present disclosure, a non-transitory computer-readable storage medium storing instructions to provide a recommendation of vehicles is disclosed. The instructions may include executable code which, when executed by a processor 104, may cause the processor 104 to receive diagnostic data associated with a vehicle; derives a first set of parameters based on an analysis of the diagnostic data; process, using a trained model, the diagnostic data and the first set of parameters to generate a user profile and a plurality of scores associated with the user profile; compare each score within the plurality of scores to corresponding predetermined threshold levels to determine a vehicle recommendation for the user profile; and provide the vehicle recommendation to the user.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually, and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The abstract of the disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, the inventive subject matter may be directed to less than all of the features of any of the disclosed embodiments. Thus, the following claims are incorporated into the Detailed Description, with each claim standing on its own as defining separately claimed subject matter.

The above-disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents and shall not be restricted or limited by the foregoing detailed description.

What is claimed is:

1. A method for providing a recommendation for selecting a vehicle, the method being implemented by at least one processor, the method comprising:
receiving, by the at least one processor, diagnostic data associated with a vehicle; deriving, by the at least one processor, a first set of parameters based on an analysis of the diagnostic data;
processing, by the at least one processor using a trained model, the diagnostic data and the first set of parameters to generate a user profile and a plurality of scores associated with the user profile;
comparing, by the at least one processor, each score within the plurality of scores to corresponding predetermined threshold levels for determining a vehicle recommendation for the user profile; and
providing, by the at least one processor, the vehicle recommendation to a user.

2. The method as claimed in claim 1, wherein the diagnostic data comprises at least one from among a throttle position, an engine revolutions per minute (RPM), a fuel consumption rate, an engine load, a steering angle, a brake pedal pressure, a transmission gear position, vehicle stability control data, a driving global positioning system (GPS) location, a driving time, a driving duration, and a coolant temperature.

3. The method as claimed in claim 1, wherein the first set of parameters comprises at least one from among a time of day, a trip duration, frequency of stops, route types, a driving smoothness, an acceleration pattern, a deceleration pattern, and an ideal time.

4. The method as claimed in claim 1, wherein the diagnostic data is received from an on-boarding diagnostic (OBD) module.

5. The method as claimed in claim 1, wherein the method further comprises:
receiving, by the at least one processor, feedback from the user in response to the vehicle recommendation.

6. The method as claimed in claim 1, wherein the diagnostic data is received upon successful validation and transformation by the at least one processor.

7. The method as claimed in claim 1, wherein the trained model is trained using a set of vehicle data associated with a plurality of vehicles and a set of user profile data associated with a plurality of users.

8. The method as claimed in claim 1, wherein the method further comprises:
providing, by the at least one processor, the vehicle recommendation to at least one external application that is associated with a platform.

9. A computing device configured to provide a recommendation for selecting a vehicle, the computing device comprising:
a processor;
a memory; and
a communication interface coupled to each of the processor and the memory, wherein the processor is configured to:
receive diagnostic data associated with a vehicle;
derive a first set of parameters based on an analysis of the diagnostic data;
process, using a trained model, the diagnostic data and the first set of parameters to generate a user profile and a plurality of scores associated with the user profile;
compare each score within the plurality of scores to corresponding predetermined threshold levels to determine a vehicle recommendation for the user profile; and
provide the vehicle recommendation to a user.

10. The computing device as claimed in claim 9, wherein the diagnostic data comprises at least one from among a throttle position, an engine revolutions per minute (RPM), a fuel consumption rate, an engine load, a steering angle, a brake pedal pressure, a transmission gear position, vehicle stability control data, a driving global positioning system (GPS) location, a driving time, a driving duration, and a coolant temperature.

11. The computing device as claimed in claim 9, wherein the first set of parameters comprises at least one from among a time of day, a trip duration, frequency of stops, route types, a driving smoothness, an acceleration pattern, a deceleration pattern, and an ideal time.

12. The computing device as claimed in claim 9, wherein the diagnostic data is received from an on-boarding diagnostic (OBD) module.

13. The computing device as claimed in claim 9, wherein the processor is further configured to receive feedback from the user in response to the vehicle recommendation.

14. The computing device as claimed in claim 9, wherein the diagnostic data is received upon successful validation and transformation by the processor.

15. The computing device as claimed in claim 9, wherein the trained model is trained using a set of vehicle data associated with a plurality of vehicles and a set of user profile data associated with a plurality of users.

16. The computing device as claimed in claim 9, wherein the processor is further configured to provide the vehicle recommendation to at least one external application that is associated with a platform.

17. A non-transitory computer readable storage medium storing instructions for providing a recommendation for selecting a vehicle, the storage medium comprising executable code which, when executed by a processor, causes the processor to:
receive diagnostic data associated with a vehicle;
derive a first set of parameters based on an analysis of the diagnostic data;
process, using a trained model, the diagnostic data and the first set of parameters to generate a user profile and a plurality of scores associated with the user profile;
compare each score within the plurality of scores to corresponding predetermined threshold levels to determine a vehicle recommendation for the user profile; and
provide the vehicle recommendation to a user.

18. The storage medium as claimed in claim 17, wherein the diagnostic data comprises at least one from among a throttle position, an engine revolutions per minute (RPM), a fuel consumption rate, an engine load, a steering angle, a brake pedal pressure, a transmission gear position, vehicle stability control data, a driving global positioning system (GPS) location, a driving time, a driving duration, and a coolant temperature.

19. The storage medium as claimed in claim 17, wherein the first set of parameters comprises at least one from among a time of day, a trip duration, frequency of stops, route types, a driving smoothness, an acceleration pattern, a deceleration pattern, and an ideal time.

20. The storage medium as claimed in claim 17, wherein the diagnostic data is received from an on-boarding diagnostic (OBD) module.
